(19) United States
(12) Patent Application Publication
(10) Pub. No.: US 2026/0202853 A1
(43) Pub. Date: Jul. 16, 2026

(54) METHOD OF CONTROLLING A MINING VEHICLE AND SCHEDULING SYSTEM FOR GENERATING A DRIVING SCHEDULE FOR A MINING VEHICLE

(71) Applicant: ABB Schweiz AG, Baden (CH)

(72) Inventors: Rickard Lindkvist, Vasterås (SE); Max Astrand, Umeå (SE); Lisa Onnerlov, Skelleftea (SE)

(21) Appl. No.: 19/135,524

(22) PCT Filed: Dec. 6, 2022
(86) PCT No.: PCT/EP2022/084607

§ 371 Date: Jun. 4, 2025

(51) Int. Cl. G05D 1/644; B60L 5/04; B60L 15/20; G05D 1/65; G05D 1/69; G05D 105/05

(52) U.S. Cl. CPC G05D 1/644; B60L 5/04; B60L 15/2009; G05D 1/65; G05D 1/69; B60L 2200/36; B60L 2200/44; G05D 2105/05

(57) ABSTRACT

A method of controlling a mining vehicle is disclosed. The vehicle is one of a plurality of mining vehicles. At least two of the plurality of mining vehicles are electrically connectable to a power delivery infrastructure. Each of the plurality of vehicles has a power status while traveling along a target path, the power status including a power demand or a power surplus. The method includes determining fleet status data, the fleet status data including a position and optionally target path data of each of the plurality of vehicles. The method includes, based on input data including the fleet status data, generating a driving schedule including instructions to control a movement of the vehicle along the target path. Generating the driving schedule includes optimizing the driving schedule according to penalties, the penalties including a penalty term indicative of a power surplus of the plurality of vehicles.

### CROSS-REFERENCE TO RELATED APPLICATIONS

The present application is a national phase entry of International Patent Application No. PCT/EP2022/084607, filed on Dec. 6, 2022, and titled “METHOD OF CONTROLLING A MINING VEHICLE AND SCHEDULING SYSTEM FOR GENERATING A DRIVING SCHEDULE FOR A MINING VEHICLE”, which is hereby incorporated by reference in its entirety.

### TECHNICAL FIELD

Aspects of the present disclosure relate to controlling an electric mining vehicle in a fleet of mining vehicles by generating an optimized driving schedule, particularly by including a penalty term indicative of a power surplus of vehicles within the fleet.

### BACKGROUND

Mining vehicles often include electric traction motors, which may be powered by a diesel-electric drivetrain or even an external electrical power source, such as an energy supply infrastructure, such as trolley lines. Catenary lines and/or trolley systems are often provided along ramps or other gradient and/or sloped pathways to provide electrical energy to mining vehicles going uphill, which may greatly reduce fossil fuel consumption.

Recent developments further suggest including on-board batteries into mining vehicles, which may power the electric motor for extended periods, thus potentially further reducing the need for fossil fuels while the mining vehicle is operated in an area without an external electrical power source.

In many mining vehicles, the electric traction motor may be used as a brake. Advantageously, braking with the electric traction motor may reduce wear on mechanical brakes and the drivetrain. Furthermore, the electrical energy regenerated during braking may be utilized by the vehicle itself, for example for charging an on-board battery, or be fed into the energy supply infrastructure, such as the trolley line. The energy may then be used by another vehicle connected to the energy supply infrastructure, thus reducing the power demand from external energy sources.

However, during operation of a vehicle fleet, more energy may be regenerated than may be utilizable by the fleet, resulting in an energy surplus, which may result in the regenerated energy being wasted, for example in a dump resistor of the vehicle or through conversion losses within the energy supply infrastructure.

Thus, there is a need for operating one or more vehicles in a fleet of vehicles so that the transfer of power between vehicles is optimized. The methods and systems described herein may solve the above-stated problem at least in part.

### BRIEF DESCRIPTION

According to an aspect, a method of controlling a mining vehicle is described. The vehicle is one of a plurality of mining vehicles. At least two of the plurality of mining vehicles are electrically connectable to a power delivery infrastructure. Each of the plurality of vehicles has a power status while traveling along a target path, the power status including a power demand or a power surplus. The method includes determining fleet status data, the fleet status data including a position and optionally target path data of each of the plurality of vehicles. The method includes, based on input data including the fleet status data, generating a driving schedule including instructions to control a movement of the vehicle along the target path. Generating the driving schedule includes optimizing the driving schedule according to penalties, the penalties including a penalty term indicative of a power surplus of the plurality of vehicles.

According to an aspect, a scheduling system for generating a driving schedule for a mining vehicle is described. The vehicle is one of a plurality of mining vehicles. At least two of the plurality of mining vehicles are electrically connectable to a power delivery infrastructure. Each of the plurality of vehicles has a power status while traveling along a target path, the power status including a power demand or a power surplus. The scheduling system includes a communication device configured for receiving fleet status data including a position and optionally target path data of each of a plurality of vehicles, and a modelling engine. The scheduling system is configured for, based on input data including the fleet status data, generating a driving schedule including instructions to control a movement of the vehicle along the target path. Generating the driving schedule includes optimizing the driving schedule according to penalties, the penalties including a penalty term indicative of a power surplus of at least one of the plurality of vehicles.

According to an aspect, a mining vehicle is described. The mining vehicle may be, for example, a load, haul and dump (LHD) machine, a mining truck, a bolter, a driller and/or a pickup truck. Passenger vehicles, such as road cars, trains, aircraft or boats are not considered mining vehicles in the context of this disclosure. The mining vehicle may be a diesel-electric truck. The mining vehicle may be a battery electric vehicle. Accordingly, the mining vehicle may include an on-board battery. The battery may essentially be the sole source of on-board traction power of the vehicle, or the battery may be provided in addition to a drivetrain including a combustion engine, such as in a diesel electric vehicle, particularly a hybrid diesel electric vehicle. The on-board battery may be a battery providing power to a traction motor. According to an aspect, the mining vehicle may be controlled by an operator, such as a driver. Additionally, or alternatively, the mining vehicle may be remote controlled, semi-autonomous or even fully autonomous and/or self-driving.

According to an aspect, a plurality of mining vehicles is described. The plurality of mining vehicles may be a fleet. The plurality of mining vehicles may be heterogenous. For example the plurality of mining vehicles may include one or more battery electric mining vehicles, one or more diesel electric mining vehicles, and/or one or more hybrid diesel electric mining vehicles. Furthermore, the plurality of mining vehicles may include non-electric vehicles, or electric vehicles not configured to be connected to a power delivery infrastructure.

According to an aspect, the mining vehicle is operated in an industrial site and/or industrial structure, such as a mine, and/or in or in between an industrial site associated with a mine, such as a processing plant, a logistics installation, a shipping yard or the like. The industrial structure may herein be referred to as a mine. A mine may be an underground mine or an above-ground mine. The mine may have a layout, such one or more pathways and/or roads, particularly a network of roads. The mining vehicle may operate along paths on the network. During operation, a vehicle may travel along a target path, such as to perform a task, such as hauling material from a first location to a second location.

According to an aspect, a target path is described. A target path may be a representation of a path to be travelled by a vehicle in the mine, such as to fulfil a haul plan. For example, a haul plan may define a starting point, such as a material pickup point, and an endpoint, such as a material delivery point. Accordingly, a target path may be represented by the starting point and an endpoint, which may correspond to the starting point and/or the end point of the haul plan, or define a section of the path to be travelled by the vehicle in-between the starting point and the end point. Additionally, or alternatively, particularly in mines or sections of mines having a simple road and/or path infrastructure, such as a single road, a target path may be represented by the position of the vehicle in the mine and/or the direction the vehicle will be traveling. Accordingly, in the simple example, the starting point may be the position of the vehicle, and the end point may be the end of the section. A target path may be definable for example for each section powered with a power delivery infrastructure such as a trolley line, and include a position of the vehicle along the power delivery infrastructure and a direction the vehicle intends to travel along the trolley line. In more complex situations and/or models, such as in mines having road networks with multiple possible routes for the vehicle to travel to fulfil the haul plan, a target path may further represent a route to be taken by the vehicle along the network.

According to an aspect, a power delivery infrastructure is described. A mining vehicle may be an electric mining vehicle, or operate in a fleet of mining vehicles including a plurality of electric mining vehicles. An electric mining vehicle is connectable to the power delivery infrastructure. Accordingly, at least two of the plurality of mining vehicles may be connectable to the power delivery infrastructure. Different types of power delivery infrastructure may be provided, such as catenary lines and/or overhead lines, powered rails, inductive power transfer systems, or other known technologies. The plurality of vehicles may be connectable and/or connected to the same power delivery infrastructure. The power delivery infrastructure may be configured for powering the electric mining vehicle, particularly while the electric mining vehicle is driving. The power delivery infrastructure may be configured for electrically connecting, at least within a section, at least two of the plurality of electric mining vehicles.

According to an aspect, the power delivery infrastructure is provided along a length of a path in the mine. Beneficially, the power delivery infrastructure may be provided along a section of a path that may require the vehicle to provide a traction power to the traction motor for powering the vehicle, for example along a road having an inclination. Beneficially, while driving uphill, the electric mining vehicle may receive electrical power from the power delivery infrastructure for powering the traction motor, which may reduce the power requirement from an on-board battery or diesel-electric drivetrain.

According to an aspect, each of the plurality of vehicles, particularly each of the vehicles connectable to the power delivery infrastructure, has a power status while traveling along a target path, the power status comprising a power demand or a power surplus. In particular, each vehicle may have a power status of a plurality of possible power statuses, the possible power statuses including a power demand, and a power surplus. A power demand may be 0. Likewise, a power surplus may be 0. Generally, a vehicle with a power demand should not have a power surplus, and a vehicle with a power surplus should not have a power demand. The power status may be considered a net energy requirement, which may be both positive and negative, or even be in an equilibrium, an equilibrium indicating that the vehicle has neither a power demand nor a power surplus. For example, a vehicle requiring power to power the traction motor may have a power demand. For example, a vehicle braking with the electric traction motor and regenerating energy may have a power surplus. The power status may be considered a power status of the vehicle with respect to the power delivery infrastructure, for example a power surplus may indicate that the vehicle may feed power to the power delivery infrastructure, and a power demand may indicate that the vehicle may receive power from the power delivery infrastructure. A power surplus of the plurality of vehicles may indicate that, when the power surplus and the power requirement of the plurality of vehicles is combined, a net power surplus is present, in other words vehicles of the plurality of vehicles with a power surplus are generating more energy than may be utilized by vehicles of the plurality of vehicles having a power demand.

According to an aspect, a driving schedule is described. A driving schedule may include one or more instructions to control a movement of the mining vehicle. In particular, the driving schedule may include one or more instructions to control a movement of the mining vehicle along the target path, such as in a section of the target path. The driving schedule may include instructions for controlling a speed of the vehicle along the target path, particularly along positions and/or sections of the target path. For example, the driving schedule may include instructions that, when followed by the vehicle, cause the vehicle to arrive at a point along the target path at a predefined time. For example, the driving schedule may include instruction that, when followed by the vehicle, cause the vehicle to remain at a point along the target path for a predefined amount of time, such as instructions for stopping the vehicle for a predefined amount of time and/or for entering a section of the target path at a defined time. Accordingly, a speed of the vehicle may be understood as a rate of movement, such as a distance travelled within a timespan, and/or a desired interval to be spent by the vehicle in a section of, or even a position along the target path. In particular, the speed of the vehicle, as defined by the driving schedule, may not necessarily be a constant speed. For example, the driving instructions may define a speed of the vehicle as remaining inside a position and/or section of the target path for a predefined amount of time, and/or leave the position and/or section at a predefined timepoint or after a predefined timespan following the entry of the section and/or position has expired. Accordingly, a speed of the vehicle may be defined as the vehicle travelling at a defined rate of movement, and/or even remaining in a stationary position for a defined amount of time.

According to embodiments, an industrial site is described. In the industrial site, a vehicle of the plurality of vehicles generating surplus energy is configured for supplying the surplus energy to the power delivery infrastructure. A vehicle of the plurality of vehicles having a power demand is configured for receiving the surplus energy. For example, two or more vehicles may be connected to a trolley line. A first vehicle may feed electrical energy into the trolley line, and a second vehicle may receive the electrical energy via the trolley line, for example to power a traction motor.

An advantage of the present disclosure may include seamlessly integrating an optimized power transfer and utilization scheme into a production cycle by providing driving schedules to one or more vehicles. Beneficially, energy consumption due to wasting energy may be reduced. Additionally, the plurality of mining vehicles may be operated with improved efficiency, since the driving schedules are dynamically generated, and may be optimized to provide less or even no time spent waiting for a vehicle of the plurality of vehicles to pass according to static traffic rules. Additionally, in some embodiments, the efficient operation of the vehicle in the production cycle may be considered during optimization of the driving schedule, which may offer the benefits described herein without reducing, or even improving the productivity of the mining vehicle in the production cycle.

Further advantages, features, aspects and details that can be combined with embodiments described herein are evident from the dependent claims, the description and the drawings.

### BRIEF DESCRIPTION OF DRAWINGS

The details will be described in the following with reference to the figures.

FIG. 1 is a schematic side view of a target path in a mine.

FIG. 2 is a schematic plan view of a target path in a mine.

FIG. 3 shows a method of generating a driving schedule for a battery electric mining vehicle.

FIG. 4 schematically shows a scheduling system according to embodiments.

### DETAILED DESCRIPTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations.

Within the following description of the drawings, the same reference numbers refer to the same or to similar components. Generally, only the differences with respect to the individual embodiments are described. Unless specified otherwise, the description of a part or aspect in one embodiment applies to a corresponding part or aspect in another embodiment as well.

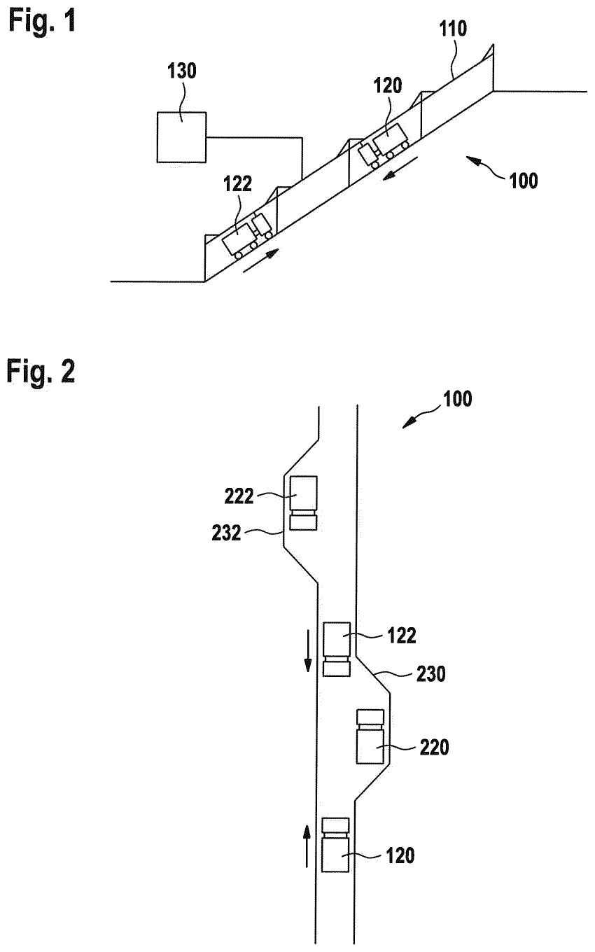

Referring now to FIG. 1 and FIG. 2, a schematic target path 100 is described. The target path 100 may be a representation of a pathway, such as one or more roads in a road network, to be travelled along by the mining vehicles 120, 122, 220 and/or 222 in a mine, for example to fulfil a certain production goal and/or haul plan, such as hauling material from a first location to a second location. Likewise, the target path 100 may be a section of a target path, such as a portion of the haul plan of the vehicles 120, 122, 220, 222.

As shown in FIG. 1, the target path 100 includes a power delivery infrastructure 110, 130. In the example, the power delivery infrastructure includes a trolley line 110 provided along a section of the target path having an inclination, which may be referred to herein as a ramp. The trolley line may deliver an electrical power to, from, and/or between the vehicles 120, 122, 220, 222. The power delivery infrastructure includes an external power source 130, such as a converter, particularly a converter for providing DC power, such as a converter for receiving power from a power delivery system and/or power grid and providing DC power to the trolley line 110 for powering the mining vehicles. Likewise, the power delivery infrastructure may be AC based, for example for providing AC power to one or more trolley lines 110.

According to embodiments, the external power source 130 may be a converter configured for converting energy received from the vehicles, such as surplus power, and feed the energy into a grid, however, this may incur conversion losses. According to embodiments, surplus energy may be converted to heat by the power delivery infrastructure 110, 130, such as by a central dump resistor to heat air or water, for example, however, there be limited demand for such heat. According to embodiments, the power delivery infrastructure may be configured for receiving surplus power from the plurality of vehicles, and provide the surplus power to other consumers in the mine.

According to embodiments, the power delivery infrastructure 110, 130 may be disconnected or disconnectable from any external power supplies. For example, the power delivery infrastructure 110, 130 may be an insular system of the mine including the trolley line 110, and may be configured for transferring power between the vehicles 120, 122, 220, 222, particularly without receiving external power such as grid power. This may reduce cost, for example by omitting the external power source 130. Optionally, the power delivery infrastructure may be configured for being connected to an energy storage system of the mine, such as a battery-based energy storage system. Accordingly, even an insular system may include a converter, for example for providing power received from the energy storage system to the trolley line 110, and/or for storing energy received from the trolley line 110 in the energy storage system.

According to embodiments, the mining vehicles 120, 122, 220, 222, may be, at least partially or even fully, powered by power received from the trolley line 110, for example by connecting to the trolley line via a pantograph-style connector, or via other connectors known in the art. Additionally, the vehicles may travel under their own power. For example, they may be powered by an on-board battery and/or a diesel-electric drivetrain.

In the example shown in FIG. 1, two mining vehicles 120, 122 are shown. Mining vehicle 122 is travelling uphill and has a power demand, such as in some embodiments the vehicle 122 is receiving power from the trolley line 110 and utilizing the power to power the traction motor. Mining vehicle 120 is travelling downhill and utilizes the electric traction motor for braking. While braking, the vehicle 120 regenerates an electrical power with the traction motor. Accordingly, the mining vehicle 120 has a power surplus, and the regenerated power may be fed, at least partly, into the trolley line 110. Since both vehicles 120, 122 are electrically connected to the same trolley line 110, the energy regenerated by vehicle 120 may be transferred via the trolley line 110 to and utilized by vehicle 122. Beneficially, since the regenerated energy is not wasted in, for example, a dump resistor, fed back into a grid or utilized for charging a battery such as an on-board battery or an energy storage system, which may incur conversion losses, the regenerated energy may be efficiently utilized. It should be noted that, while the trolley line 110 has been drawn in FIG. 1 as a continuous trolley line, several individual trolley line segments may be connected due to physical and/or spatial limitations, for example, by utilizing electrical connectors, to form an electrically connected trolley line.

As shown in FIG. 2, a target path 100 travelled by several vehicles 120, 122, 220, 222 may not allow the optimal scenario in which all the regenerated surplus energy may be utilized by a vehicle with a power demand. For example, the vehicles may follow local traffic rules to avoid potential collisions in sections of the target path 100. In the example shown in FIG. 2, the target path extends along a section in an underground mine. Due to space constraints, such as in a tunnel or drift having only one lane that may be travelled in either direction by a vehicle, in some locations along the target path, vehicles may not simultaneously travel uphill and downhill. Accordingly, bays 230, 232, such as turnout spots and/or meeting pockets, are provided. A vehicle, such as vehicle 220, 222, may enter the bays 230, 232 to allow oncoming traffic to pass. In the example shown in FIG. 2, the vehicle 220 is waiting until it can exit the bay behind vehicle 122. Next, vehicle 120 would enter the bay and allow vehicle 122 to pass. Vehicle 222 waits in the bay 232 until both vehicles 220 and 120 have passed. In the given example, the vehicles 120, 122, 220, 222 may only rarely move in a manner in which the power surplus of a vehicle going downhill may be utilized by a vehicle having a power demand while going uphill. Accordingly, by generating a driving schedule for at least one of the vehicles 120, 122, 220, 222 optimized to consider the power surplus of at least one of the plurality of vehicles, the energy regenerated for example by vehicle 122, 222 may be better utilized, for example by vehicles 120, 220.

It should be noted that, due to the above-stated problem occurring for any type of vehicle of the fleet of vehicles 120, 122, 220, 222, not every vehicle of the plurality of vehicles may necessarily be an electric mining vehicle and/or electrically connectable to the trolley line 110. For example, a diesel-powered vehicle may, just as an electric mining vehicle, cause one of the plurality of vehicles 120, 122, 220, 222 to require to wait in a bay 230, 232. Accordingly, in the systems and methods described herein, fleet status data may beneficially be determined also from non-electric vehicles, and the non-electric vehicles may be included in the generation and/or optimization of the driving schedule.

The target path 100 shown in FIG. 1 is a simplified example intended to better help understand the present disclosure and the underlying problem. According to embodiments, various modifications are possible. As shown in FIG. 1, the target path 100 may be provided along a ramp, but may also be provided in an essentially flat section of the mine. Even in an essentially flat section, mining vehicles may generate an energy surplus, such as by braking and regenerating energy, by utilizing an on-board diesel-electric motor, or even by feeding energy from an on-board battery into the trolley line. A target path 100 may include several sections and be more complex than shown in FIG. 1, for example, a target path may include different sections powered by different trolley lines such as trolley line 110, and the different trolley lines may be galvanically isolated. Accordingly, a target path may be defined for each section. Furthermore, a target path may be definable for multiple sections, for example, in some embodiments fleet status data indicating that a vehicle is about to enter a section having a trolley line may be considered to provide an optimized driving schedule for at least one of the plurality of vehicles.

It is an object of the present disclosure to provide a driving schedule including instructions to control a vehicle for at least one of the plurality of mining vehicles to reduce or even avoid situations in which a power surplus of the plurality of vehicles occurs.

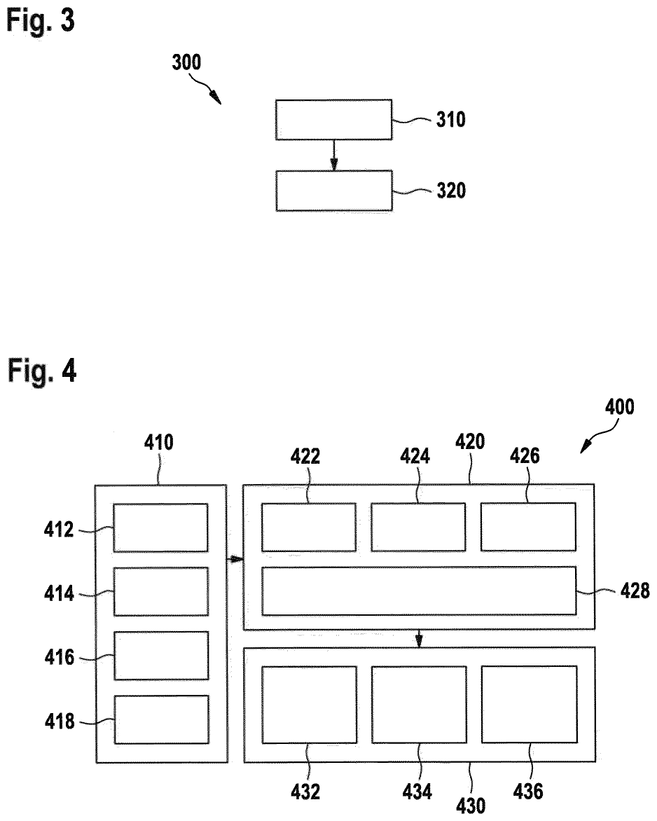

Referring now to FIG. 3, a method 300 of controlling a mining vehicle of a plurality of mining vehicles is described. The method may be applied for vehicles travelling along a target path, such as target path 100 described with reference to FIG. 1 and FIG. 2. At least two vehicles of the plurality of vehicles are electrically connectable or electrically connected to a power delivery infrastructure, such as the trolley line 110 shown in FIG. 1. Accordingly, the vehicles may transfer power, via the trolley line, between one another, particularly in cases where one vehicle has a power surplus and a second vehicle has a power demand.

In operation 310, fleet status data is determined. The fleet status data includes a position and optionally target path data of each of the plurality of vehicles. The position may be included in the target path data. The position may include a direction of the vehicle, such as a direction the vehicle should travel according to the haul plan. The position and/or the target path data may be vehicle parameters.

According to embodiments, in operation 310, additional vehicle parameters may be obtained for some or all of the plurality of vehicles. Vehicle parameters may include one or more of static vehicle parameters, dynamic vehicle parameters, vehicle constraints and/or schedule constraints.

According to embodiments, static vehicle parameters may include vehicle parameters that are essentially static for the vehicle, such as information about a make and/or model of the vehicle, a vehicle ID, information specific to the vehicle, such as weight of the vehicle, rated engine power, rated battery capacity, average and/or expected energy consumption, maintenance information, load capacity, or the like.

According to embodiments, dynamic vehicle parameters may include vehicle parameters that may change during the operation of the vehicle, such as the current load of the vehicle, data indicative of a power consumed and/or power regenerated during, for example, past operation cycles, data indicative of a state of the battery, such as the state of charge, battery deterioration, battery temperature, maximum battery charging rate, data indicative of future maintenance requirements, data indicative of the current status of the vehicle, or the like.

According to embodiments, vehicle constraints may include data indicative of performance limits of the vehicle, such as a maximum speed of the vehicle, which may be associated with a current load of the vehicle and/or target path data, such as a maximum allowed speed in a section of the target path, for example an uphill section, maximum load, maximum power draw, expected energy consumption along a section of the target path, or the like.

According to embodiments, schedule constraints may include data indicative of constraints associated with a schedule of the vehicle, such as scheduled breaks and/or shift end times, expected maintenance intervals, scheduled cooldown periods, or the like.

In operation 320, a driving schedule is generated based on input data. The input data includes the fleet status data, and may include further data, such as vehicle parameters and/or data related to the target path. The driving schedule includes instructions to control a movement of the vehicle along the target path. A driving schedule may be generated for one, several, or even all of the plurality of vehicles. The driving schedule may further be generated based on the vehicle parameters and/or further data obtained in operation 310.

In operation 320, a driving schedule is generated that allows the plurality of vehicles to move according to each vehicle's haul plan. For example, the driving schedule may define when a vehicle enters a section of the target path, if a vehicle should allow another vehicle to pass, which speed a vehicle should travel along the section of the target path, if a vehicle should wait, for example at a defined location, for a defined amount of time, and/or other potentially variable, feasible driving instructions. According to embodiments, the plurality of vehicles may be routed and/or scheduled according to scheduling systems known in the art. Accordingly, since several of the instructions included in the driving schedule are variable, multiple solutions may be available to successfully route and/or schedule the plurality of vehicles, for example without causing head-on collisions in the example given with reference to FIG. 2.

Generating the driving schedule in operation 320 includes optimizing the driving schedule according to penalties. The penalties include a penalty term indicative of a power surplus of the plurality of vehicles, particularly at least two vehicles electrically connected to the power delivery infrastructure. Optimizing the driving schedule may include generating several potential driving schedules, for example driving schedules that vary according to the instructions for controlling a speed of the vehicle, and scoring the potential driving schedules according to the penalties. Optimizing the driving schedule may include selecting the schedule with the lowest penalty score, such as the schedule with the most optimal penalty score derived from the penalty term indicative of a power surplus of the plurality of vehicles.

According to embodiments, the optimization may include optimizing towards a lowest possible power surplus. This may beneficially ensue that no recovered energy is wasted, such as through conversion losses or even by being dumped. According to further embodiments, the optimization may include optimizing towards a power surplus that is in equilibrium with a power demand. This may beneficially further ensue that a low amount of, or even no external power is required for operating the vehicles.

According to embodiments, the operation 320 may include generating a model of the plurality of vehicles moving along the target path. In particular, the model may be suitable for modelling and/or simulating the vehicles travelling along the target path, and deriving data from the model, such as an expected power surplus and/or an expected power demand.

According to embodiments, the model may be suitable for generating a driving schedule. According to embodiments, the model may be suitable for obtaining, for example by modelling, data suitable for deriving penalties, such as penalty scores, including the expected power demand and/or power surplus of one or more of the plurality of vehicles along the target path. Obtaining the target path data may, additionally or alternatively, include utilizing historical data from previous trips, and in some embodiments comparable trips and/or routes of the same or similar vehicles traveling along the target path under the same or similar conditions.

According to embodiments, the target path data may include data indicative of a target path layout, a power surplus of a vehicle, and/or a power demand. According to embodiments, the target path data may, for example as a production constraint, include information about the power availability along a section of the target path, such as along a power delivery infrastructure, such as the trolley line 110. The power availability may be associated with the target path layout, and/or may be included into the driving schedule optimization as a production constraint. The power availability may be indicative of a power that may be deliverable to a vehicle while the vehicle is connected to the power delivery infrastructure. The power availability may define a power limit. The power availability may be derivable from a power providable by an external power source, and may further include the power fed into the power delivery infrastructure by a vehicle with a power surplus. The power availability may be limited according to a maximum power transferrable, for example between vehicles, via the power delivery infrastructure, such as a trolley line having a maximum current rating. The power availability may be dynamic. For example, a trolley line and/or converter may be configured for providing a limited electrical power, and in situations where multiple vehicles are receiving power from the trolley line, the power available to a single vehicle may be lower than the limited electrical power providable by the trolley line. Likewise, if a vehicle has a power surplus, the power availability may increase accordingly. The power availability may further be indicative of a power that may be regeneratable by a vehicle while the vehicle has a power surplus. The power availability may depend on and/or be derivable from vehicle parameters, such as static vehicle parameters and/or dynamic vehicle parameters. Likewise, the power availability may be derivable from historical data.

According to embodiments, the target path data may include information indicative of a power demand along a section of the target path. The power demand may be derived from vehicle parameters of one or more vehicles scheduled to drive along the section of the target path. The power demand information may, for example, be obtained from historical data, and/or may be obtained based on a model, such as a physics model, a graph-based model, and/or a model based on historical and/or statistical data, utilizing vehicle parameters and/or the fleet status data. The power demand may be indicative of an expected power draw of the one or more vehicles along a section of the target path, particularly while the vehicle is connected to the power delivery infrastructure, or may potentially interfere with a vehicle connected to the power delivery infrastructure. For example, an expected power demand exceeding the power availability may be undesirable, and be penalized accordingly during optimization of a driving schedule.

According to embodiments, the method 300 may include considering production targets and/or production constraints. For example, it may, in some situations, be counterproductive to operate a mining vehicle according to a driving schedule that is optimized solely according to a penalty term indicative of a power surplus, particularly if the mining operation is negatively affected by such a driving schedule. Production constraints may be determined in operation 310, for example as a part of the receiving of the fleet status data. Furthermore, production constraints may be determined independently of generating a driving schedule, such as before generating a driving schedule.

Accordingly, optimizing the driving schedule in operation 320 may include further penalties. The penalties may further include a penalty term indicative of production constraints. Production constraints may, for example, include time constraints. For example, a penalty based on a time constraint may result in a driving schedule that allows a higher power surplus than an optimal driving schedule, but cause the vehicle to arrive at a scheduled point in time that is within a time frame more beneficial for the production cycle. The penalties may further include a penalty term indicative of production targets. For example, a penalty based on a production target may include increasing a power demand, for example by instructing a vehicle to move uphill faster than would be feasible for the available power surplus, and/or loading more material than would be ideal in an optimal driving schedule optimized solely according to the power surplus penalty term. The penalties may further include cost parameters. For example, additionally, or alternatively, the penalty term indicative of a power surplus of a single vehicle, or even the plurality of vehicles, or even the fleet, may be considered as a cost parameter. For example, a vehicle with a power surplus that may not be utilized, for example burned in a resistor, may incur a higher cost than a vehicle that may utilize the power surplus to charge an on-board battery. For example, a vehicle with a power surplus that may not be utilized may incur a lower cost than a vehicle missing a production target, for example by being delayed. Accordingly, cost parameters may be defined to tune the optimization.

According to embodiments, optimization may include penalizing driving schedules resulting in a power surplus of the plurality of vehicles. Additionally, or alternatively, a penalty term may be defined to penalize a power demand of the plurality of vehicles, while at least one of the plurality of vehicles may potentially have a power surplus, for example by not utilizing a potential power surplus. Accordingly, a penalty term may be defined to penalize both a power surplus and a power demand, particularly in situations where the power surplus and the power demand of the plurality of vehicles may cancel each other at least in part, or even result in an equilibrium. This may beneficially allow a reduced use of external power.

According to embodiments, the method 300 may include an operation for generating a driving schedule according to aspects and/or embodiments described herein. The mining vehicle is driven according to the driving schedule. Accordingly, the method 300 may be a method of controlling an electric mining vehicle in a mine. The method may include generating a driving schedule for one or more of a plurality of mining vehicles, such as a fleet of mining vehicles, and driving the plurality of mining vehicles according to the driving schedule.

According to embodiments, the driving schedule, and/or instructions included in the driving schedule, may be communicated to the vehicle and/or a driver of the vehicle. For example, a driver may receive the instructions, via a communication device, such as a smartphone, a tablet, a walkie-talkie, a drive assist system or even an autonomous driving system integrated into the vehicle, or the like. For example, the instructions may be signaled via a roadside signaling system, such as traffic lights or display boards. Communicating the instructions may cause the vehicle to remain at a defined position for defined time, enter a defined position at a defined time, leave a position at a defined time, travel at a defined speed, or the like, for example by causing a driver to operate the vehicle according to the driving schedule. For example, instructions may include objectives, such as to drive the following section of the target path at a predefined speed, or to stop, for example at a predefined location, such as a bay, or a parking location connected to a branched-off trolley line, until an oncoming vehicle has passed, for example.

According to embodiments, the method 300 may include optimizing a driving schedule for a fleet of vehicles. The fleet of vehicles may have more vehicles than required to fulfil a haul plan or several haul plans. For example, several available vehicles may be parked, for example, in a stationary charging area, and in some embodiments having different vehicle parameters, such as a different state of charge, or the like. Accordingly, the method may include selecting a vehicle from a plurality of parked vehicles for which a driving schedule according to embodiments herein has been optimized or is optimizable according to aspects or embodiments described herein. For example, a vehicle of the available vehicles may be selected based on the best achievable penalty scores, compared to the other available vehicles. Accordingly, a driving schedule may include instructions to select a defined vehicle to fulfil a haul plan.

Referring now to FIG. 4, a schematic representation of a scheduling system 400 for generating a driving schedule for a battery electric mining vehicle is described. The scheduling system 400 may be configured for performing a method according to embodiments described herein, such as the method 300 described with reference to FIG. 3. The scheduling system may be implemented as a software, such as one or more programs to be executed by a computer system. The computer system may be communicatively connected to one or more mining vehicles, to send and receive data to and from the mining vehicles.

The scheduling system 400 includes a communication device 410 configured for receiving fleet status data. The fleet status data includes a position 412 of each of a plurality of vehicles of the fleet. Further parameters receivable by the communication device 410 may include vehicle parameters, such as static vehicle parameters 414, which may include vehicle constraints, and/or other static vehicle parameters described herein.

According to embodiments, the vehicles of the plurality of vehicles may include localization and communication devices for communicating a position of the vehicle in the mine to the communication device 410. Alternatively, the mine may include a localization infrastructure for determining the position of the plurality of vehicles, such as vehicle localization systems known in the art.

The communication device 410 may receive dynamic vehicle parameters 416, which may include, for example, a state of charge of an on-board battery, schedule constraints, and/or other dynamic vehicle parameters described herein. The dynamic vehicle parameters may be specific for each of the plurality of vehicles of the fleet.

The communication device may be configured for receiving a haul plan 418. The haul plan 418 may be specific for each of the plurality of vehicles, and may include data, such as a target location of the vehicle, a proposed route for the vehicle, or the like. The haul plan may include data indicative of and/or derivable from a target path, or may even include a target path. Alternatively, or additionally, a target path may be generatable from the haul plan 418, particularly if the target path may be complex, with a complex target path potentially including several potential routes along a network of paths.

The communication device may further be configured for receiving a mine layout. The mine layout may not necessarily be received for every driving schedule to be generated, often a model of the mine may be generated and stored in a memory of the scheduling system 400. The mine layout may be receivable, for example, if changes in the mine layout occur, such as to update the model of the mine based on the mine layout. Furthermore, historical data about a trip, such a previous trip, of a mining vehicle along a path in the mine may be communicated and be utilized such as to build or refine a model of the mine.

The communication device 410 is configured for providing the fleet status data, particularly the position 412 of each of a plurality of vehicles of the fleet, to the modelling engine 420. The modelling engine 420 may include a model 422 of the mine and/or the plurality of mining vehicles in the mine, particularly a physics model of the mine suitable for simulating the mining vehicle fleet travelling along paths in the mine, particularly a model configured for simulating and/or modelling a power status of the mining vehicles when traveling along a path of the mine. The model may further include and/or be at least partially generated based on historical data, such as previous trips of mining vehicles.

The modelling engine 420 may include constraints 424. The constraints 424 may include and/or be derived from some or all of the constraints described herein. In particular, the constraints may be indicative of vehicle constraints, schedule constraints, target path data, and/or production constraints. The constraints may be utilizable by the modelling engine to generate a driving schedule that does not go beyond limitations defined by the constraints, such as physical limitations of the vehicles and/or the power delivery infrastructure, or virtual constraints, such as non-feasible driving schedules missing production goals.

The modelling engine may include a cost function 426. The cost function 426 max define cost parameters, and may further be utilized, for example by the optimizer 428, to evaluate the cost, based on the parameters, of one or more driving schedules, such as potential driving schedules. In particular, the cost function may define the penalty term indicative of a power surplus of the plurality of vehicles as a cost parameter, and allow evaluating the power status of the plurality of vehicles as a penalty. According to some embodiments, production targets may be defined and/or evaluated, based on cost parameters. For example, not fulfilling a production target may incur a penalty based on a cost parameter. According to embodiments, cost parameters may be defined to incur a negative penalty, such as an incentive, to incentivize optimizations resulting in beneficial outcomes.

The modelling engine 420 may include an optimizer 428, such as an optimization routine. The optimizer 428 may be configured for optimizing variable parameters based on the data provided by the communication device 410 and/or the constraints 424 and cost function 426, such as a value indicative of a speed and/or time interval of the vehicle in a charging section, an unpowered section and/or a road section of the target path. In particular, the optimizer 428 may generate a plurality of potential driving schedules, and compare the potential driving schedules according to the cost function 426, for example by comparing the penalties associated with the potential driving schedule. Accordingly, the optimizer 428 may be configured for obtaining a cost score and/or a penalty score by utilizing the model 422, for example for modelling and/or simulating the vehicle along the target path when driving according to the potential driving schedules, and may further be configured for utilizing the cost function 426 to score the potential driving schedules according to a penalty. For example, the model 422 may allow estimating an energy demand of a vehicle while traveling along the target path, an amount of energy recoverable of a vehicle while traveling along the target path, and a power status indicative of a power surplus of the plurality of vehicles. The optimizer 428 may be configured for selecting a driving schedule from the potential driving schedules based on the penalties associated with the driving schedules. In other words the optimizer may select an optimized driving schedule.

According to embodiments, the modelling engine 420 may be implemented in commercially available simulation, planning, control, automation and/or modelling solutions, such as known solutions for optimizing industrial processes. Known solutions include, but are not limited to, the ABB Ability™ Expert Optimizer and related optimization-based functionalities, the ABB Ability™ Edgenius product family, the ABB Ability™ Operations Management System, and/or the ABB Ability™ System 800xA product family, as available at the time of filing of this disclosure.

According to embodiments, the scheduling system may generate a driving schedule 430. The driving schedule may be communicated to the mining vehicle, for example by the communication device 410. The driving schedule may be optimized for reducing power states of the plurality of vehicles in which there is a power surplus along the target path. The driving schedule 430 includes instructions to control a movement of at least one of the plurality of vehicles along the target path, such as instructions described herein controlling a speed of the mining vehicle.

In particular, the instructions 432 may, for one or more of the plurality of vehicles, or even all of the plurality of vehicles, define a speed of the vehicle in a segment of the target path. Additionally, or alternatively, the instructions 434 may define a time to enter or leave a segment. Additionally, or alternatively, the instructions 434 may include instructions to enter, remain in, and/or exit a bay at a defined time, such as described herein with reference to FIG. 2.

According to embodiments, the driving schedule may include an estimation of the energy savings 436. The estimation may be based on the cost function 426, and/or be generated by applying the optimizer 428 and/or modelling the plurality of vehicles in the modelling engine 420. The estimation of the energy savings 436 may beneficially allow reviewing the driving schedule, for example by a third party or even a driver of the vehicle.

Beneficially, referring to the problem stated with reference to FIG. 2, the improved scheduling system and method of controlling an electric mining vehicle may generate one or more driving schedules for the vehicles 120, 122, 220, 222 to cause two vehicles to be traveling up and down the ramp simultaneously, thus reducing the power surplus of the plurality of vehicles. For example, when following an optimized driving schedule, vehicle 120 may enter the bay 230 behind vehicle 220. As soon as vehicle 122 has passed vehicle 220, vehicles 122 and 220 travel along the ramp simultaneously in opposite directions, the regenerated energy of vehicle 122 being utilized by vehicle 220 instead of being burned in a dump resistor. This may beneficially increase energy utilization.

According to embodiments, while the foregoing has been exemplary described in the context of controlling a speed of one or more vehicles along a target path having a space constraint being mitigated by scheduling the vehicles to enter and/or exit waiting bays at predefined timepoints, other and/or more general problems may formulated and be solved, at least in part, by the proposed scheduling system and method of controlling an electric mining vehicle. For example, a driving schedule may be generated before the vehicle enters a target path having a power delivery infrastructure, and the driving schedule may cause the vehicle to wait until a beneficial scenario, for example two vehicles driving in opposite directions so that regenerated energy may be transferred from one vehicle to another vehicle, is generated by following the optimized driving schedule. This may beneficially reduce a power surplus in a mine having several power delivery infrastructures, such as several insulated trolley lines. Accordingly, an industrial site according to embodiments may include a plurality of segments, and each segment may include a (separate) power delivery infrastructure. Accordingly, a target path may include multiple segments.

According to embodiments, an industrial site including a scheduling system according to embodiments described herein is described. The scheduling system may be provided on-site. Additionally, or alternatively, the scheduling system may be provided off-site, for example the industrial site may be communicatively connected to a scheduling system that may be provided as a cloud-based service, such as on a remote server.

According to embodiments, the industrial site, particularly devices, sensors, a power delivery infrastructure, vehicles traveling within the industrial sites, production facilities associated with the industrial sites, and/or signaling devices may be communicatively connected to the scheduling system 400, particularly the communication device 410. The data, parameters, driving schedules, constraints and/or further types of data may be communicated through a communication system of the industrial site, such as a data network of the industrial site.

According to embodiments, the scheduling system 400, particularly the communication device 410, may comprise a network interface for connecting the device to a data network, in particular a global data network. The data network may be a TCP/IP network such as Internet. The scheduling system 400 is operatively connected to the network interface for carrying out commands received from the data network, and/or for sending commands to be carried out. The commands may include a control command for controlling the device to carry out a task such as generating a driving schedule 430. In this case, the scheduling system 400 is adapted for carrying out the task in response to the control command. The commands may include a status request. In response to the status request, or without prior status request, the scheduling system 400 may be adapted for sending a status information to the network interface, and the network interface is then adapted for sending the status information over the network. The commands may include an update command including update data. In this case, the scheduling system 400 is adapted for initiating an update in response to the update command and using the update data.

The data network may be an Ethernet network using TCP/IP such as LAN, WAN or Internet. The data network may comprise distributed storage units such as Cloud. Depending on the application, the Cloud can be in form of public, private, hybrid or community Cloud.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A method for controlling a mining vehicle of a plurality of mining vehicles, wherein:
at least two of the plurality of mining vehicles are electrically connectable to a power delivery infrastructure,
each of the plurality of mining vehicles has a power status while traveling along a target path,
the power status comprises a power demand or a power surplus, and
the method comprises:
determining fleet status data, wherein the fleet status data comprises a position of each of the plurality of mining vehicles; and
based on input data including the fleet status data, generating a driving schedule comprising instructions to control a movement of the vehicle along the target path, wherein
generating the driving schedule comprises optimizing the driving schedule according to penalties, wherein the penalties comprise a penalty term indicative of a power surplus of the plurality of mining vehicles.

2. The method according to claim 1, wherein the power delivery infrastructure includes a trolley line configured to provide electric power along at least a portion of the target path.

3. The method according to claim 1, wherein the penalties further comprise production constraints, production targets, and/or cost parameters.

4. The method according to claim 3, wherein a production constraint includes a power limit of the power delivery infrastructure.

5. The method according to claim 1, wherein the driving schedule includes instructions to control a speed of the vehicle along the target path.

6. The method according to claim 1, wherein the driving schedule includes instructions to stop the vehicle for a predefined amount of time and/or to enter a section of the target path at a defined time.

7. The method according to claim 1, wherein generating the driving schedule includes:
generating a model of the plurality of mining vehicles moving along the target path,
estimating penalties based on the model, and
optimizing the driving schedule according to the penalties.

8. The method according to claim 1, further comprising:
controlling the mining vehicle in a mine; and
driving the mining vehicle in the mine according to the driving schedule.

9. A scheduling system for generating a driving schedule for a mining vehicle of a plurality of mining vehicles, wherein:
at least two of the plurality of mining vehicles are electrically connectable to a power delivery infrastructure,
each of the plurality of mining vehicles has a power status while traveling along a target path, the power status comprising a power demand or a power surplus, and
the scheduling system comprises:
a communication device configured to receive fleet status data comprising a position, and
a modelling engine, wherein the scheduling system is configured to, based on input data including the fleet status data:
generate a driving schedule comprising instructions to control a movement of the vehicle along the target path, wherein the generation of the driving schedule comprises optimizing the driving schedule according to penalties, wherein the penalties include a penalty term indicative of a power surplus of at least one of the plurality of mining vehicles.

10. An industrial site comprising:
a scheduling system configured to generate a driving schedule for a mining vehicle of a plurality of mining vehicles, wherein:
at least two of the plurality of mining vehicles are electrically connectable to a power delivery infrastructure, and
each of the plurality of mining vehicles has a power status while traveling along a target path, the power status comprising a power demand or a power surplus;
the scheduling system comprises:
a communication device configured to receive fleet status data comprising a position, and
a modelling engine, wherein the scheduling system is configured to, based on input data including the fleet status data:
generate a driving schedule comprising instructions to control a movement of the vehicle along the target path, wherein the generation of the driving schedule comprises optimizing the driving schedule according to penalties, wherein the penalties include a penalty term indicative of a power surplus of at least one of the plurality of mining vehicles.

11. The industrial site according to claim 10, wherein the power delivery infrastructure is provided along a section of the target path, particularly a ramp.

12. The industrial site according to claim 10, wherein a vehicle of the plurality of mining vehicles generating surplus energy is configured to supply the surplus energy to the power delivery infrastructure.

13. The industrial site according to claim 10, wherein the power delivery infrastructure is disconnected from any external power supplies.

14. The industrial site according to claim 10, wherein the industrial site comprises a plurality of segments, and wherein each segment comprises a power delivery infrastructure.

15. The industrial site according to claim 10, wherein the mining vehicle is an electric mining truck.

16. The method of claim 1, wherein the fleet status data further comprises target path data of each of the plurality of mining vehicles.

17. The scheduling system of claim 9, wherein the fleet status data further comprises target path data of each of the plurality of mining vehicles.

18. The industrial site of claim 10, wherein the fleet status data further comprises target path data of each of the plurality of mining vehicles.

19. The industrial site of claim 12, wherein a respective vehicle of the plurality of mining vehicles has a power demand and is configured to receive the surplus energy.
